(19) United States
(12) Patent Application Publication
(10) Pub. No.: US 2004/0116557 A1
(43) Pub. Date: Jun. 17, 2004

(54) Paving and sealing composition and method of use

(76) Inventors: Randall j Pounds, Kingwood, TX (US); Eric Moll, Humble, TX (US)

Correspondence Address: Sue Z Shaper, Suite 930, 2925 Briar Park Drive, Houston, TX, 77042, US

(21) Appl. No.: 10/363,159

(22) PCT Filed: Aug. 17, 2001
(86) PCT No.: PCT/US01/25809

(51) Int. Cl. C08J 3/00; C08K 3/34; C08K 11/00

(52) U.S. Cl. 524/59; 525/221; 524/442

(57) ABSTRACT

The composition and method of the present invention may be used for repairing potholes (10, 52), sealing or paving surfaces (10), curbs (93) and/or for interfacing, between paving (74) and structural members (72, 73). The preferable composition includes a mixture of a rubberized compound and an ethylene-unsaturated carboxylic acid co-polymer having a carboxylic acid content from about 0.5 to about 40 weight percent of the co-polymer. The rubberized compound may preferably be natural or synthetic rubber compounds, rubberized tar or the like. The ethylene-unsaturated carboxylic acid co-polymer preferably may be ethylene acrylic acid or the like. This composition may include a reinforcing agent, such as aggregate (16, 18, 56, 60), or a modifying agent, such as natural or synthetic fibers.

This application is co-pending with and claims the benefits of U.S. Serial No. 60/230,114, filed Sep. 5, 2000 and U.S. Serial No. 60/231,808, filed Sep. 11, 2000, both herein incorporated by reference.

### FIELD OF INVENTION

The field of the invention relates to composition and methods used to fill potholes of, pave in some circumstances, seal, provide interfaces with and repair curbs of roadway and other outdoor structural surfaces, more particularly employing thermoplastic compounds, and preferably employing elastic compounds with improved impact absorbing and flexible characteristics.

### BACKGROUND

Since the advent of hard surfaced roads, the traveling public has been plagued with the problem of potholes. The causes of these dangerous and property damaging cavities in road surfaces vary somewhat, from the southern to the northern sections of the United States. However, most stem from moisture or water seeping through cracks in pavement down into the soil beneath. This water either freezes, thus creating expansion and forces the substrata upward or washes away the substrata leaving voids beneath the paving surface. Traffic exerts pressure on this weakened area and the surface crumbles thereby creating a pothole.

The pothole problem is worsening. Since 1960 there was at least an increase of 75 million registered vehicles in the United States. Thirty million of these were trucks with an ever-increasing gross weight allowance. These heavy trucks have accounted for 90% of the decrease in road surface longevity.

Potholes are frequently filled twice a year, once with a cold patch and again with a hot patch. The hot patch is used when the mean temperature rises above freezing. During this time between fills the weight of heavy traffic dislodges the pothole fill and causes a perpetual problem.

In northern areas, freezing and contraction of pavement surfaces causes the main problem. In southern areas, heat causes expansion and buckles the pavement surface.

Asphalt is a common paving surface. Extensive use is made of asphalt paving as a means for surfacing for general traffic use, both on primary and secondary roads, as well as parking lots and, in some locations, as sidewalks. Asphalt is a dark brown to black cementitious material in which the predominating constituents are bitumens which occur in nature or are obtained in petroleum processing. (The Asphalt Institute considers the term “asphalt” to include asphalt cements, asphalt fluxes, asphalt cutbacks, asphalt emulsions, asphalt road oils, roofing and waterproofing asphalts and all other asphalts and asphalt residuums used in the manufacture of asphalts and asphalt specialties. Such widespread use creates an ongoing demand for repair and preventative maintenance.) Over prolonged periods of time, for various reasons, the asphalt surface deteriorates or fails or is otherwise damaged and requires repair. As is known, asphalt pavements in need of maintenance or repair can exhibit any or all of the following conditions:

“Raveling” is the progressive separation of aggregate particles in a pavement from the surface downward. Usually, the fine aggregate comes off first and leaves little “pock marks” in the pavement surface. As the process continues, larger and larger particles are broken free, and the pavement soon has the rough and jagged appearance typical of surface erosion. Raveling can result from lack of compaction during construction, during wet or cold weather, dirty or disintegrating aggregate, poor mix design, or extrinsic damage to the pavement.

“Shrinkage Cracks” are interconnected cracks forming a series of large blocks, usually with sharp corners or angles. They are caused by volume changes in the asphalt mix, in the base, or in the subgrade. “Alligator Cracks” are interconnected cracks forming a series of small blocks resembling an alligator's skin or chicken wire. In most cases, alligator cracking is caused by excessive deflection of the surface over unstable subgrade or lower courses of the pavement. The unstable support usually is the result of saturated granular bases or subgrade. The affected areas in most cases are not large; sometimes, however, they will cover entire sections of a pavement, and when this happens, it usually is due to repeated loadings exceeding the load-carrying capacity of the pavement.

“Upheaval” is the localized upward displacement of a pavement due to swelling of the subgrade or some portion of the pavement structure. In colder climates, upheaval is commonly caused by expansion of ice in the lower courses of the pavement or the subgrade. It may also be caused by the swelling effect of moisture on expansive soils.

“Potholes” are bowl-shaped holes of various sizes in the pavement, resulting from localized disintegration of the pavement under traffic. Contributory factors can be improper asphalt mix design, insufficient pavement thickness, or poor drainage. Also, potholes may simply be the result of neglecting other types of pavement distress.

“Grade Depressions” are localized low areas of limited size which may or may not be accompanied by cracking. They may be caused by traffic heavier than that for which the pavement was designed, by settlement of the lower pavement layers, or by poor construction methods.

One major failure of asphalt surfacing results from moisture penetration of the base material. This penetration of moisture is generally caused and/or accelerated by overloading small units of area through numerous repetitive cycles until the asphalt covering disrupts or separates. Once this occurs, of course, moisture seeps into the base material and not only naturally deteriorates the material, but also may freeze and cause separation of large amounts or quantities of material which are reduced to small particles by continued use of the surface thus eventually causing a hole or depressed area commonly called a “pothole” as set forth earlier.

In order to prevent or minimize this type of damage from occurring, the asphalt surface is periodically sealed with a seal coat solution that penetrates any separations or disruptions in the asphalt surface thus preventing moisture from entering therein. If, however, the pothole occurs, one way to prevent additional damage is to trim and excavate the failed area or pothole, remove any dust, dirt or excess materials, reseal the exposed base to preclude any additional moisture from entering therein and replacing the removed asphalt surface with a cold or hot asphalt mix and tamping, compacting, or rolling the hot or cold mix until it achieves the proper density and elevation with respect to the surrounding asphalt surface.

Numerous pavements have a concrete surface rather than asphalt. Concrete pavement frequently requires resurfacing. One proposed method of resurfacing concrete structures has been to employ an epoxy resin such as a reaction product of epichlorohydrin and bisphenol in which polymerization is stopped before a solid product of higher molecular weight is obtained. In that application, it is essential that the epoxy resin employed be liquid at ambient temperature in order that the composition may be applied to a damp concrete surface. The mixture further includes a polyamide resin component and a filler such as sand washed free of soluble salts and having particle size of 30 mesh or smaller. A second filler of finer particle size can also optionally be included to give better packing during application of the composition to the road surface. Coloring agent or dye such as iron oxide, titanium or carbon black can be included as an optional component. Illustrative of such resurfacing technique is U.S. Pat. No. 2,934,452.

Other cold patching techniques have been developed primarily for asphaltic surfaces. Once such technique involves the coating of a cold patch material or mixing such cold patch material, with a solution of a thermoplastic polymeric resin. The solvent causes resin penetration into the patching material and the pavement area adjacent the patch. After the solvent volatilizes a thermoplastic resin is provided which purportedly adds strength to the patched area and provides a greater water repellency for the patched area and more firmly secures the patch to the surrounding area. In filling large potholes, the resin solution is thoroughly mixed with the patch material and compacted in the pothole such as by rolling or vibratory compaction. The compaction can be accompanied by heat which assists in volatilization of the solvent after the solvent has penetrated the patch and the area surrounding it. In order to obtain the best adhesion, it is preferred in this method to place some of the resin solution on the wall of the cavity prior to inserting the fill material within the cavity. The fill materials employed in this method are typically asphalt and tar. Illustrative of this method is U.S. Pat. No. 4,097,172.

Numerous patents have issued for self-contained vehicles which include hoppers for storing bituminous materials, appropriate heating sources and distribution and compaction devices for filling the pothole and compacting the fill material in the pothole. Illustrative of such self-contained vehicles are U.S. Pat. No. 2,420,410 (includes means for applying heat to the outer periphery of the pothole to assist the molten material to flow into all the cracks in a liquid condition and to maintain the material in a molten condition for the requisite time to allow full penetration); U.S. Pat. No. 4,072,435 (discloses a vehicle spreader, roller, heater combination including means for missing asphalt with aggregate); U.S. Pat. No. 3,270,632 (discloses a vehicle including means for heating bumps in a road using a propane heat source in combination with a scraping blade to even up the bumps); U.S. Pat. No. 3,625,120 (discloses a tractor with an asphalt hopper in combination with a sprayer and roller); U.S. Pat. No. 4,215,949 (discloses a vehicle with an asphalt supply hopper, burner, tack oil sprayer and a tamper); U.S. Pat. No. 3,564,985 (discloses a unitary vehicle carrying asphalt and propane heaters for the purposes of pavement repair); U.S. Pat. No. 4,198,177 (illustrates a unitary vehicle for repair of asphalt surfaces including an emulsion tank containing a water soluble, air cured sealer bonding agent and an air compressor driven by the vehicle engine. The vehicle cooling liquid is used for heating the emulsion to a useable temperature while the compressor sprays the emulsion on the surface to be repaired.).

U.S. Pat. No. 4,744,693, to W. C. Smith, discloses a pothole filling formulation which comprises a polyolefin, such as ethylene-unsaturated carboxylic acid co-polymer, combined with gravel aggregate particles of one-quarter inch dimension or larger. A pothole filling method is also disclosed which includes placing the polyolefin and gravel aggregate mixture in a pothole. A heat source then melts the polyolefin in the hole and causes it to flow within the pothole to fill up the crevices in the pothole. A second layer of aggregate is applied to the top surface of the fill before the polyolefin hardens to improve the skid resistant qualities of the fill as well as to minimize any deleterious effects of ultraviolet light from the sun. W. C. Smith's pothole filling formulation, however, can be brittle in some circumstances and not exhibit the low temperature toughness needed in northern climates. This prior art patent also does not address the problem of how the performance characteristics of the formulation might be effectively modified by the combination with other compounds for given applications. And heating in the hole may have cost and time disadvantages

Therefore, a need exists for a more cost effective method of filing potholes, paving and/or sealing roadway and other outdoor surfaces, interfacing roadways with structures and repairing curbs with a composition and method that has cost and performance benefits, including speed, efficiency, toughness, hardness, resiliency, thermal stability and/or color, and that preferably may be adjusted for given applications. The present invention disclosed herein meets these and other needs.

### SUMMARY OF THE INVENTION

It has been discovered that the composition and method of the present invention may be used to repair a hole in a paved surface and to create a temporary, semi-permanent, or permanent patch on potholes or cracks in asphalt or bituminous roadways, concrete roadways, pavements, runways, aprons, or other surfaces that are used for transportation. The composition and method may be used for paving roadway and other outdoor surfaces, such as roadways, bridge surface, particularly metal bridge decks, as well as walls, pools or ponds. Also, the composition and method of this invention may be used to seal outdoor structural surfaces, such as bridge columns, bridge piers, roofs, pools or ponds. Further, this invention may be used for improving the impact resistance of an interface between roadways and roadway structures, such as manhole boxes, drain bores, and expansion joints. The composition and method may be used to repair curbs.

The composition of this invention includes an ethylene-unsaturated carboxylic acid co-polymer having a carboxylic acid content from about 0.5 to about 40 weight percent of the co-polymer that may be used alone in some specialized applications and/or preferably be combined with a rubberized compound as well as possibly a reinforcing agent, a modifying agent, an additive compound and/or a coloring agent. The ethylene-unsaturated carboxylic acid co-polymer is preferably essentially at least one of acrylic acid, methacrylic acid, ethacrylic acid, crotonic acid, vinyl acetic acid, maleic acid and/or fumaric acid. The rubberized compound is preferably essentially at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and/or ground rubber tires. In general rubberized compound refers to any of numerous synthetic elastic materials of varying chemical composition with properties similar to those of natural rubber. The reinforcing agents include aggregates, metal rods or plastic strips and the like. Modifying agents include natural or synthetic fibers, calcium carbonate, talc or other minerals.

This invention in one embodiment provides a method for repairing a hole in a paved surface with a composition of this invention which preferably includes a step of mixing a rubberized compound with an ethylene-unsaturated carboxylic acid co-polymer having a carboxylic acid content from about 0.5 to about 40 weight percent of the co-polymer to form a mixture; heating the mixture with a heat source until the mixture is substantially melted; and preferably pouring the substantially melted mixture into a hole in a paved surface so that the hole in the paved surface is substantially repaired when the melted mixture is sufficiently cooled and substantially solidified. This method may also include placing a reinforcing agent into the hole and/or heating the hole prior to adding the substantially melted mixture.

This invention in one embodiment provides a method of applying an adhesive paving compound to surfaces in specialized circumstances, which method preferably includes heating an ethylene-unsaturated carboxylic acid co-polymer with a heat source until the co-polymer is substantially melted and applying the co-polymer, preferably as substantially melted, to a surface so that the co-polymer forms an adhesive bond with the surface when the co-polymer substantially solidifies. Although the repair of roads and the paving of roads are similar, no one has ever paved a surface with EAA because of the perception that it would be too expensive. EAA is many times more expensive (×100) than asphalt. One aspect of the present invention is the recognition that in some applications, such as bridges with metal surfaces or any structure that has some flex and/or vibration, EAA and EAA/rubber becomes the only product that can do the job. On some bridges where there is a vibration problem it could be solved with a thick (heavy) application of asphalt or cement. However, the weight restrictions make this impractical.

This invention in another embodiment provides a method of applying an impact resistant and adhesive paving compound to surfaces in specialized circumstances, which method preferably includes the steps of forming a mixture of a rubberized compound and an ethylene-unsaturated carboxylic acid co-polymer; heating the mixture with a heat source until the mixture is substantially melted; and applying the mixture, preferably as substantially melted, to a surface so that the co-polymer and the rubberized compound form adhesive bonds with the surface to form a paved surface when the melted mixture is substantially solidified. The preferred surfaces to which an adhesive and/or impact resistant paving compound is applied include bridge decks, roadways, airport runways or aprons, parking lots, loading docks, building floors and/or sidewalks, walls, pools and ponds. The surface may have a decorative effect.

This invention in one embodiment provides a method for sealing surfaces, which method includes the steps of heating an ethylene-unsaturated carboxylic acid co-polymer with a heat source until the co-polymer is substantially melted; adding an additive compound and possibly a modifying agent and/or a reinforcing agent to selectively adjust the physical properties of the substantially melted copolymer; applying the selectively adjusted co-polymer, preferably as substantially melted, to one or more surfaces so that the co-polymer forms adhesive bonds that seal said surfaces when the co-polymer is cooled and substantially solidified. The physical property that may be adjusted preferably includes ductility, toughness, elastic modulus, compression modulus, flexural modulus, tensile strength and flexural strength. Such surfaces preferably include bridge columns, bridge piers, roofs, ponds and pools. On many bridge columns there are rust stains. The internal rusting of the steel support in the cement columns often causes these stains. One aspect of the present invention is that a coating of EAA or mixture will “seal” the column and prevent further rusting.

This invention in another embodiment provides a method of applying an impact resistant and adhesive seal to an interface between a roadway and a roadway structure, which method preferably includes mixing a rubberized compound and an ethylene-unsaturated carboxylic acid co-polymer; heating the mixture with a heat source to form a substantially melted mixture; and applying the (preferably substantially melted) mixture to an interface between a roadway and a roadway structure to form an impact resistant adhesive bond or seal between said roadway and roadway structure when the substantially melted mixture is cooled and substantially solidified. The roadway structures that might be sealed with this method preferably include manhole boxes, drain boxes, roadway curbs and expansion joints.

This invention in a further embodiment includes a method of applying an adhesive seal to an interface between a roadway and a roadway structure, which method preferably includes heating an ethylene-unsaturated carboxylic acid co-polymer with a heat source to form a substantially melted co-polymer; and applying the (preferably substantially melted) co-polymer to an interface between a roadway and a roadway structure to form an adhesive bond or seal between said roadway and roadway structure. The roadway structures that may be sealed with this method preferably include manhole boxes, drain boxes, roadway curbs and expansion joints.

This invention in one embodiment includes a method of modifying the physical properties of a compound containing ethylene acrylic acid. At least one physical property such as ductility, toughness, elastic modulus, compression modulus, flexural modulus, tensile strength and/or flexural strength is preferably selected for a compound containing ethylene acrylic acid. A desired value for the physical property for the compound containing ethylene acrylic acid is determined. An effective amount of an adjusting compound is added to an amount of the compound containing ethylene acrylic acid to adjust the physical property of the mixture to the desired value of the physical property. The adjusting compound preferably includes a rubberized compound and possibly a reinforcing agent, a modifying agent and combinations thereof.

The present invention in another embodiment includes a method of repairing a roadway curb, which method preferably includes placing a mold proximate a portion of a roadway curb to be repaired. An appropriate solvent/lubricant is applied to the mold. The ethylene-unsaturated carboxylic acid co-polymer is heated with a heat source until substantially melted. The (preferably substantially melted) co-polymer is poured into the mold to repair the hole in the roadway curb when the melted co-polymer is substantially solidified and the mold is removed from the roadway curb.

### BRIEF DESCRIPTION OF THE DRAWINGS

FIG. 1 illustrates steps of a method of repairing a hole in a paved surface in accordance with one embodiment of this invention.

FIG. 2 illustrates the composition and method of an embodiment of this invention applied to a partial depth repair of a roadway.

FIG. 3 illustrates the composition and method of an embodiment of this invention applied to a full depth repair of a roadway.

FIG. 4 is a graph of load-deflection versus flexural strength tests that were conducted at 70° F. for compositions of this invention.

FIG. 5 is a graph of load deflection versus flexural strength tests that were conducted at 32° F. for compositions of this invention.

FIG. 6 is graph of compression strength versus strain curves.

FIGS. 7A and 7B illustrate the composition of an embodiment of this invention in a construction use sealing an interface between a manhole and a roadway.

FIG. 8 illustrates the composition of an embodiment of this invention in a construction use sealing an interface between an expansion joint and a roadway.

FIG. 9 illustrates the composition of an embodiment of this invention in a construction use sealing an interface between a roadway curb and a roadway.

FIG. 10 shows the composition of this invention in a construction use sealing an interface between a roadway drain and a roadway.

### DETAILED DESCRIPTION OF PREFERRED EMBODIMENTS

A preferred composition of this invention comprises ethylene-acrylic acid co-polymer used alone or mixed with rubberized compounds, and possibly including modifying agents, reinforcing agents and/or fillers. This composition may be used for forming and repairing roadways, curbs, walls, structures and general road surfaces. Due to its adhesive properties, this composition may be applied to specialized surfaces such as bridge columns, outdoor structures and buildings that need protection against moisture. Also, the composition and method of this invention may be used for sealing vertical surfaces.

A preferred composition of the present invention comprises generally a polyolefin, preferably an acidized co-polymer having high adhesive properties, and which is preferably combined with a rubberized compound and possibly other modifying agents. Any suitable thermoplastic polyolefin could be used, however, such polyolefin should have the desired properties of adhesion, strength (compressive and shear) and be stable in a wide range of temperatures. The type of polyolefin that may be employed in the present invention include co-polymers of ethylene and carboxylic acids wherein carboxyl groups are randomly distributed along the length of the polymer chain, preferably, a beta-ethylenically unsaturated carboxylic acid. The acid content of the polyolefin may vary from 0.5% to 40% by weight of the co-polymers. The carboxyl groups on different chains can bond together or cross-link to give the material the strength and the other desirable properties. Also, the carboxyl groups may attach the chain to a substrate surface, which may be metal or paving surfaces containing concrete or asphalt. The carboxylic acids that may be utilized in this invention preferably include acrylic acid, methacrylic acid, ethacrylic acid, crotonic acid, vinyl acetic acid, maleic-acid, fumeric acid and others derived from ethylene and unsaturated carboxylic acids.

In a preferred embodiment, the polyolefin may be PRIMACOR®, manufactured by the Dow Chemical Company. PRIMACOR® is an ethylene-acrylic acid co-polymer having 20% acrylic acid content. PRIMACOR® has the following properties:

| | | |
|---|---|---|
| Melt Index, g/10 min | ASTM D-1-38 | 1200-2600 |
| Melt Flow Rate, g/10 min | ASTM D-1238 | 8.0-16.5 |
| Acid Content, % | ASTM D-4094 | 18-22 |
| Density | ASTM D-792 | 0.95-0.96 |
| Ultimate Tensile Strength, psi | ASTM D-638 | 600-1400 |
| Elongation, % | ASTM D-638 | 300-390 |
| 2% Secant Modulus, psi | ASTM D-790 | 2600-3200 |
| Hardness, Shore D | ASTM D-2240 | 40-44 |
| Crystalline Melting Point | | 165-209 |
| IR Spectrophotometric Analysis | DOTD TR-610 | Pass |

Other types of polyolefin that may be used in this invention includes Nucrel®, a co-polymer of ethylene, acrylic acid and methacrylic acid, by Dupont or BASF Lucalen®, an ethylene acrylate co-polymer, including other like co-polymers.

In this invention, one or more rubberized compounds may be combined with a polyolefin, as noted above. The rubberized compound is a material that is similar to that used as a standard crack sealer for sealing of narrow joints in roadways. This material alone has little or no compressive strength and does not respond well to temperature variances. The rubberized compounds preferably include rubberized tar, rubberized asphalt, ground rubber tires, and natural rubbers. Moreover, such rubberized compounds and/or modifiers may be products such as:

a. W R Meadows 3405 (Polymeric Rubberized Tar);

b. Uniroyal Chemical Trilene 77 and IM-7200 (polyolefin that is Ethylene-Propylene-Ethylidene Norborne Terpolymer and the like);

c. Ricon 156, 131, 100, 3100 (Butadiene homopolymer, Butadiene co-polymer, Styrene-Butadiene co-polymer, and Methacrylate oligomer);

d. Goodyear Natsyn (Polyisoprene Rubber);

e. Shell's SEBS, SBS, SBLS, SIS, SBCS and EPOM; and

f. Other rubberized or polymeric tars manufactured by Deering, Crafco Industries, Koch or W. R. Meadows.

The composition of this invention may include reinforcing agents, such as aggregate, metal rods, plastic strips or other members used in concrete or asphalt reinforcement. “Aggregate” is used in the context of rock or gravel particles or other materials exhibiting similar physical properties. Also, the composition may include fillers or modifying agents, such as natural or synthetic fibers, calcium carbonate, talc or other minerals that may be used to take up volume in the composition.

In a preferred embodiment, the composition and method of this invention includes a beta-ethylenically unsaturated carboxylic acid co-polymer, such as EAA, that may be combined with a rubberized compound, such as rubberized tar, that may be formulated into a mixture. The ratio of co-polymer to rubberized compound ranges from about 1 percent to about 60 to 80 percent by weight or by volume. Preferably, this ratio is 50/50 by weight or volume. More preferably, this ratio is a minimum of 15 percent EAA to a maximum of 80 percent rubberized compound, by weight or volume and has dimensional stability from −50 to 170 degrees F. Tests were performed to establish a preferred composition for asphalt roads. It has been demonstrated that a composition of an 20/80 ratio of EAA to rubberized compound is preferred. This composition remains dimensionally stable over a wide variety of temperatures and humidity in the range from about −70 to about 250 degrees F. and is suitable for paving roads, both in southern climates (i.e., Louisiana) as well as northern climates (i.e., Chicago, Ill., USA and the City of Edinburgh, Scotland, UK).

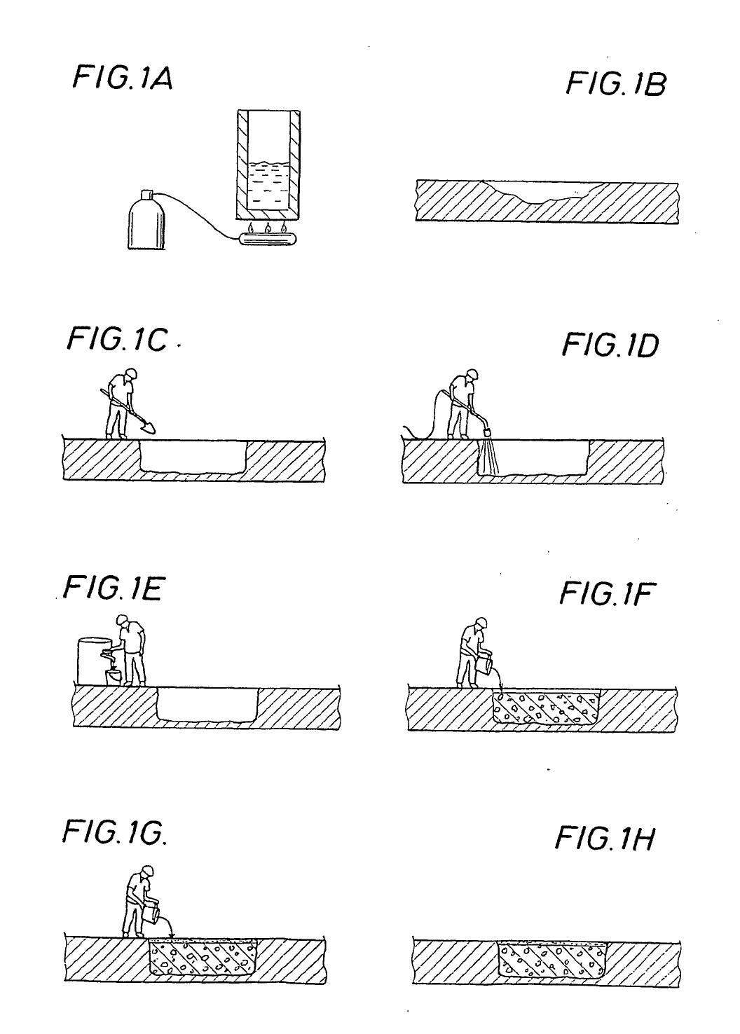

Referring now to FIG. 1, they illustrate one method of repairing a paving surface having a hole, FIG. 1B. In Step 1, a mixture is prepared of a rubberized compound and an ethylene-unsaturated carboxylic acid co-polymer, as discussed herein. (Preparing a mixture should be understood to be broad enough to encompass incorporating a rubberized compound into EAA during a polymerization process.) In Step 2, FIG. 1A, the mixture is heated until it is substantially melted. In Step 3, FIG. 1E, the substantially melted mixture is poured into a hole in a paved surface. Also, FIGS. 1C and 1D, any loose aggregate and/or pavement may be removed from the hole prior to pouring the melted mixture in the hole. Reinforcing or modifying agents, such as aggregate or fibers, may be optionally placed in the hole, FIG. 1F. These agents may be added to the hole either before the mixture is poured into the hole or while the mixture is already in hole. The mixture is allowed to cool until substantially solidified in order to effectuate a repair of the roadway, FIG. 1H. A top surface with fine aggregate may be provided, FIG. 1G.

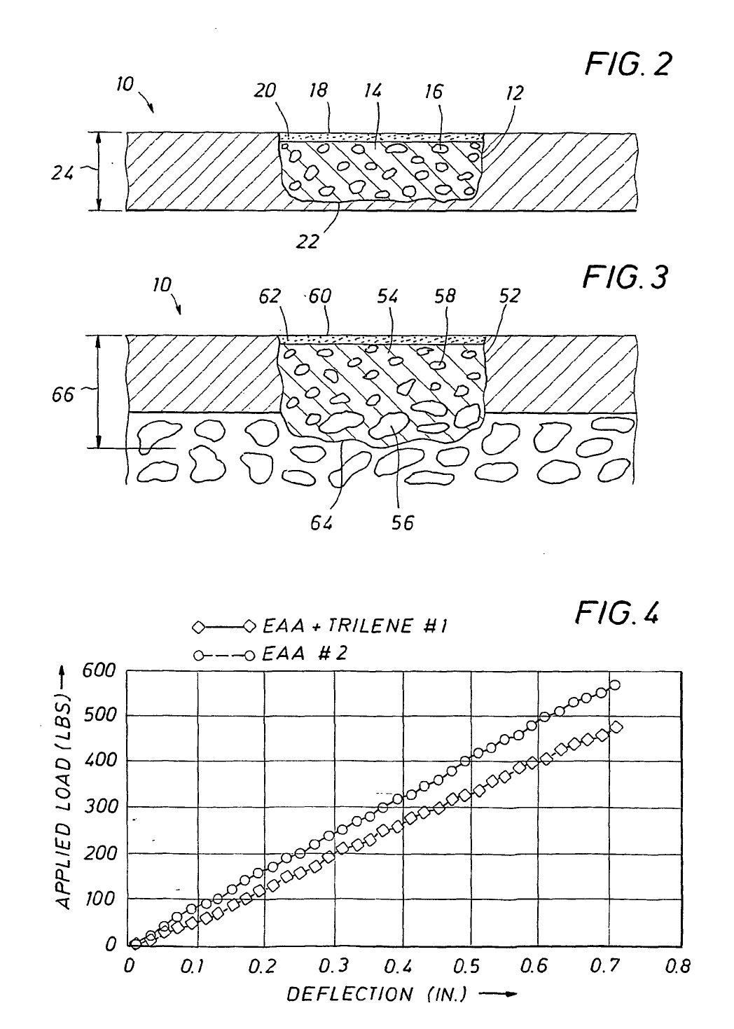

FIG. 2 shows a partial depth repair of a hole in a paved surface which may be concrete, asphalt or bituminous. Paved surface 10 has a hole 12 that does not penetrate the entire depth 24 of the paved surface. This is called a partial depth hole. Hole 12 may be cleaned of loose aggregate and/or pavement material and/or dressed down to good road material, prior to being repaired. Composition 14 of this invention is mixed, melted and then poured into hole 12 according to the method of this invention. A reinforcing agent 16 may also be added to composition 14 while in hole 12 or be added to hole 12 beforehand. Such reinforcing agent 16 is shown as medium size aggregate. A substantially water-tight seal is formed between composition 14 and reinforcing agent 16. In addition, a substantially water-tight seal is formed between composition 14 and the sides 22 of hole 12. A layer of composition 14 and fine aggregate 18 may be used as a top layer 20 of the substantially repaired paved surface.

FIG. 3 shows a full depth repair of a hole in a paved surface which may be concrete, asphalt or bituminous. Paved surface 10 has a hole 52 that penetrates the entire depth 66 of the paved surface. This is called a full depth hole to the subsurface, including substructure base course of earth, limestone or the like. Hole 52 may be cleaned of loose aggregate or pavement base course and/or dressed down to good road material, if present, prior to being repaired. Composition 54 of this invention is mixed, melted and then poured into hole 52 according to the method of this invention. Reinforcing agent 56 may also be added to composition 54 while in hole 52 or be added to hole 52 beforehand. Such reinforcing agent 56 is shown as large and medium size aggregate. A substantially water-tight seal is formed between composition 54 and reinforcing agent 56. In addition, a substantially water-tight seal is formed between composition 54 and the sides 64 of hole 52. A layer of composition 54 and fine and/or medium aggregate 60 may be used as a top layer 60 of the substantially repaired paved surface.

The aggregate is then placed in the hole (as a variation aggregate can be added into the melting pot before pouring). The aggregate adds compressive strength. This aggregate is usually aggregate sized 16 (pea gravel) and added to a mixture of approximately 35/65 mixture/gravel. The aggregate/mixture is then leveled off and a fine layer of aggregate (aggregate 18) is added on the surface. This is done for better tire traction, better surface appearance, and to form a barrier against ultraviolet (UV) rays which may damage the EAA. In contrast to prior art methods, such as W. C. Smith's patent, UV lamps are not needed for curing the compound.

The method of repairing concrete or asphalt of this invention may include mixing a co-polymer, a rubberized compound, a modifying agent and a reinforcing agent together until a uniform mixture is achieved. The handling of this mixture may be simplified if these constituents are pre-blended and packaged in meltable plastic bags. This mixture is heated with a heat source. The heating may occur in the pothole being repaired, but such is less efficient. Preferably, the heating and mixing may be performed in an oil jacketed kettle or tar pot. The mixture may then be poured into the pothole being repair or otherwise applied to the road. Alternatively, aggregate may be added before a substantially melted mixture is added to patch the road being repaired. Also, the mixture material may be cooled and formed into blocks for later use or storage.

### ILLUSTRATIVE EXAMPLES OF EAA/TAR MIXTURES ESP. FOR ASPHALT FORMULATIONS

| Rubberized Tar | EAA |
|---|---|
| 0% Tar | 100% EAA |
| 0% Tar | 90% EAA |
| 20% Tar | 80% EAA |
| 30% Tar | 70% EAA |
| 40% Tar | 60% EAA |
| 50% Tar | 50% EAA |
| 60% Tar | 40% EAA |
| 70% Tar | 30% EAA |
| 80% Tar | 20% EAA |
| 90% Tar | 10% EAA |
| 100% Tar | 0% EAA |

The ratio of aggregate (rock) to EAA/rubberized tar material may range from 0% (for greater flexibility) to 90% (for greater compressive strength) by weight or volume percentage.

### Concrete Formulations

For concrete applications an embodiment of the invention includes EAA mixed with many different types of rubbers such as natural rubbers, Graton™ and Trilene™. A preferred embodiment of the invention includes a composition which may comprise 50% EAA and 50% Rubber Trilene, and more preferably 80% EAA and 20% Trilene.

### Physical Testing

### Test 1

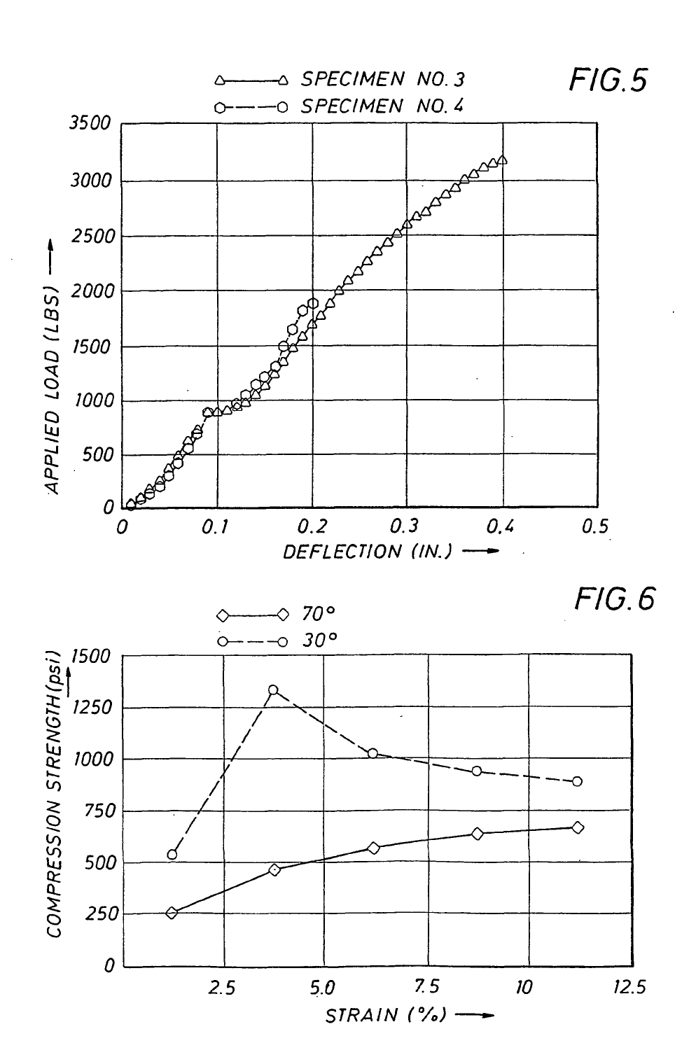

Four representative specimens were tested. Specimens 1 & 3 were made with 20% Trilene & 80% Ethyl Acrylic Acid (EAA) by weight. Specimens 2 & 4 were made with EAA alone. Specimens 1 & 2 were left at room temperature (70° F.). Specimens 3 & 4 were cooled to 32° F. The specimens were made by placing the materials in a pan, heating to 350° F. and stirred to evenly consolidate the different materials. The samples (after heating) were then placed in a mold and load tested when correctly cooled. The specimens dimensions and testing procedures were in general accordance to the ASTM C-293 Standard Test Method for Flexure Strength of Concrete (Using Simple Beam With Center-Point Loading). The depth of the specimens were 3.00″, the span length was 9.00″ and the width was 2.90″. The results of the testing performed are shown in Table 1, shown graphically in FIGS. 4 and 5.

TABLE I
Material Flexural Strength Test (ASTM C-293)
3″ × 3″ × 12″ Beam

| | Applied Load, lbs. | | | |
|---|---|---|---|---|
| Deflection | # 1 | # 2 | # 3 (32° F.) | # 4 (32° F.) |
| 0.01 | N/A | N/A | 40 (32° F.) | 30 (32° F.) |
| 0.02 | 10 | 20 | 110 | 80 |
| 0.03 | N/A | N/A | 180 | 130 |
| 0.04 | 30 | 40 | 260 | 180 |
| 0.05 | N/A | N/A | 370 (34.5° F.) | 280 (34° F.) |
| 0.06 | 40 | 60 | 480 | 411 |
| 0.07 | N/A | N/A | 620 | 540 |
| 0.08 | 50 | 80 | 710 | 690 |
| 0.09 | N/A | N/A | 880 | 880 |
| 0.10 | 60 | 90 | 890 (37.5° F.) | 880 (37° F.) |
| 0.11 | N/A | N/A | 900 | 900 |
| 0.12 | 70 | 100 | 930 | 940 |
| 0.13 | N/A | N/A | 970 | 1020 |
| 0.14 | 90 | 120 | 1040 | 1130 |
| 0.15 | N/A | N/A | 1120 (39° F.) | 1190(38° F.) |
| 0.16 | 100 | 140 | 1220 | 1260 |
| 0.17 | N/A | N/A | 1340 | 1470 |
| 0.18 | 120 | 160 | 1470 | 1620 |
| 0.19 | N/A | N/A | 1570 | 1800 |
| 0.20 | 130 | 170 | 1680 (39° F.) | 1870 (38° F.) |
| 0.21 | N/A | N/A | 1760 | Modulus of |
| | | | | Rupture 965 |
| | | | | PSI |
| 0.22 | 150 | 190 | 1870 | |
| 0.23 | N/A | N/A | 1980 | |
| 0.24 | 160 | 200 | 2080 | |
| 0.25 | N/A | N/A | 2170 (40.5° F.) | |
| 0.26 | 170 | 220 | 2270 | |
| 0.27 | N/A | N/A | 2350 | |
| 0.28 | 190 | 240 | 2440 | |
| 0.29 | N/A | N/A | 2510 | |
| 0.30 | 210 | 250 | 2590 (41° F.) | |
| 0.31 | N/A | N/A | 2670 | |
| 0.32 | 220 | 270 | 2710 | |
| 0.33 | N/A | N/A | 2800 | |
| 0.34 | 230 | 280 | 2870 | |
| 0.35 | N/A | N/A | 2930 (42° F.) | |
| 0.36 | 250 | 300 | 3000 | |
| 0.37 | N/A | N/A | 3050 | |
| 0.38 | 260 | 320 | 3110 | |
| 0.39 | N/A | N/A | 3150 | |
| 0.40 | 280 | 330 | 3710 (42) | |
| 0.41 | N/A | N/A | Modulus of Rupture 1640 PSI | |
| 0.42 | 290 | 350 | | |
| 0.43 | N/A | N/A | | |
| 0.44 | 300 | 360 | | |
| 0.45 | N/A | N/A | | |
| 0.46 | 320 | 380 | | |
| 0.47 | N/A | N/A | | |
| 0.48 | 330 | 400 | | |
| 0.49 | N/A | N/A | | |
| 0.50 | 340 | 420 | | |
| 0.51 | N/A | N/A | | |
| 0.52 | 360 | 430 | | |
| 0.53 | N/A | N/A | | |
| 0.54 | 370 | 450 | | |
| 0.55 | N/A | N/A | | |
| 0.56 | 390 | 460 | | |
| 0.57 | N/A | N/A | | |
| 0.58 | 400 | 480 | | |
| 0.59 | N/A | N/A | | |
| 0.60 | 410 | 500 | | |
| 0.61 | N/A | N/A | | |
| 0.62 | 430 | 510 | | |
| 0.63 | N/A | N/A | | |
| 0.64 | 440 | 530 | | |
| 0.65 | N/A | N/A | | |
| 0.66 | 450 | 540 | | |
| 0.67 | N/A | N/A | | |
| 0.68 | 460 | 550 | | |
| 0.69 | N/A | N/A | | |
| 0.70 | 480 | 570 | | |

As shown in Table 1 and FIGS. 4 and 5, composition of the present invention exhibits much improved flexural strength and toughness, particularly at low temperatures such as about 32 degrees F. This particularly true in the deflection at failure for EAA combined with a rubberized compound as compared to EAA alone. It is believed that the EAA and rubberized compound are adhesively bonded to form a matrix of EAA and rubberized compound. As such, the imparted forces may be transmitted across the matrix and enable the rubberized compound to deflect to a much greater degree before failure.

### Test 2

Six representative specimens were requested to be tested for tensile and compressive strength. The specimens consisted of 71% crushed limestone, 14.5% Ethyl Acrylic Acid and 14.5% rubberized tar (by weight). The crushed limestone had fines passing the #200 sieve and aggregates greater than the ¼″ sieve removed. The materials were placed in a pan, heated to 350° F. and stirred to uniformly mix the different materials. The mixed product was then placed into molds and allowed to cool. Three of the six samples were lowered to 30° F. and the other three were allowed to cool to room temperature (70° F.). The specimens were tested in general accordance to ASTM D-638, ASTM C-109 & ASTM C-293. The results of the testing performed are as follows:

TABLE II
TENSILE TEST RESULTS (ASTM D-638)

| Testing | Tensile |
|---|---|
| Temperature | Strength, psi |
| 70° F. | 247 |
| 30° F. | 477 |

TABLE III
COMPRESSION TEST RESULTS (ASTM C-109)

| Testing | | | | | |
|---|---|---|---|---|---|
| Temperature, | Compression Strength | | | | |
| ° F. | 2.5 | 5.0 | 7.5 | 10.0 | 12.5 |
| 70° F. | 254 | 467 | 565 | 642 | 673 |
| 30° F. | 534 | 1333 | 1018 | 948 | 893 |

TABLE IV
FLEXURAL STRENGTH TEST (ASTM C-293)

| | | Modulus |
|---|---|---|
| Testing | Total | of |
| Temperature, ° F. | Load | Rupture |
| 71 | 673 | 350 |
| 26 | 1520 | 785 |

See FIG. 6 for a graph of Table III average results.

### Test 3

Two representative samples were requested for pull out testing. The first sample consisted of 70% crushed limestone, and 30% Ethyl Acrylic Acid (by weight). The second sample consisted of 15% rubberized tar, 15% Ethyl Acrylic Acid and 70% crushed limestone (by weight). The crushed limestone was sieved over a ¾″ sieve and the +¾″ aggregate was removed. The materials were placed in a pan, heated to 350° F. and stirred to uniformly mix the different materials. The mixed samples were then placed into pothole mockups (concrete with small jackhammered 3″ potholes) and were pull tested using an eye hook embedded into the patching material. The results of the testing performed are as follows:

TABLE V
Patch Mockup Pull Out Test

| | | | Failure |
|---|---|---|---|
| Specimen # | Description | Load, lbs. | Location |
| 1 | Limestone-Ethyl Acrylic Acid | 1130 | Mat'l/Conc. |
| | | | Interface |
| 2 | Limestone-Rubberized Tar-Ethyl | 920 | Mat'l/Conc. |
| | Acrylic Acid | | Interface |

### Test 4

An Impact Test was performed on EAA alone and shattered at 0° F., the rubberized (50%) mixture did not fracture.

Two samples (one pure EAA), one with 50% rubberized tar and one with 50% EAA, were frozen to −40° F. A drop test (7′) over a concrete floor was preferred. The pure EAA broke, and the rubberized material was received in tact.

As show in the physical testing above, the physical properties of a compound containing ethylene acrylic acid may be modified using a rubberized compound. A physical property such as ductility, toughness, elastic modulus, compression modulus, flexural modulus, tensile strength or flexural strength is selected for a compound containing ethylene acid. A desired value for the physical property for the compound containing ethylene acrylic acid is determined. An effective amount of an adjusting compound is added to an amount of the compound containing ethylene acrylic acid to adjust the physical property of the mixture to the desired value of the physical property. The adjusting compound includes a rubberized compound, and may include a reinforcing agent, a modifying agent and combinations thereof.

The present invention may be used for a variety of applications. In one embodiment, the composition and method may be used for paving surfaces, more particularly load-bearing surfaces, but also structural surfaces such as walls and pool or pond surfaces, in particular their bottoms. The composition of this invention which forms a matrix between the co-polymer and the rubberized compound is well suited for difficult surfaces, such as metal bridge decks which have low adhesion and encounter high vehicular vibrations. In the case of EAA and rubberized tar, an EAA-rubberized tar matrix forms adhesive bonds that binds with the low adhesive surface of the metal bridge deck. The matrix also absorbs the vehicular and other transmitted vibrations. A reinforcing agent, such as aggregate or sand may be added to give greater strength and to provide a rougher surface for vehicular traffic. The agent might also add a decorative feature.

In another embodiment, the composition and method of this invention may be used to seal surfaces, such as a roof, more particularly, a flat metal roof and also walls and pool and pond surfaces and bottoms. Also, it may be used to seal a bridge column or a roadway curb. In the case of roadway curbs, a solvent such as WD-40™ must be applied to curb forms. When using EAA co-polymer alone, for example, the acidic moieties form adhesive bonds with the surfaces to seal such surfaces to keep out moisture. When using EAA and rubberized tar, for example, the rubber in the matrix form provide low temperature toughness. The physical properties of the co-polymer, such as viscosity, toughness, adhesive strength, gloss, reflectivity, and thermal conductivity as well as others, may be selectively adjusted by adding one or more modifying compounds. Such modifying compounds include metal flakes or chips, ceramics, natural fibers, synthetic fibers, calcium carbonate, talc, other minerals natural rubber, butadiene homopolymer, styrene-butadiene co-polymer, methacrylic oligomer, polymeric rubberized tar, ethylene-proplylene-ethylidene norborn terpolymers, polyisoprene rubber, rubberized asphalt and ground rubber tires. The ceramics or metal flakes provide reflective or insulation properties and include glass, zirconia, yttria or aluminum. Such ceramics or metal flakes may be incorporated with the EAA and/or rubberized tar, or may be spread on top of the composition after it is applied. The ceramics include ceramic flakes, dust or ceramic spheres, such as Z-light Spheres™ and Zeeospheres™, manufactured by the 3M Company.

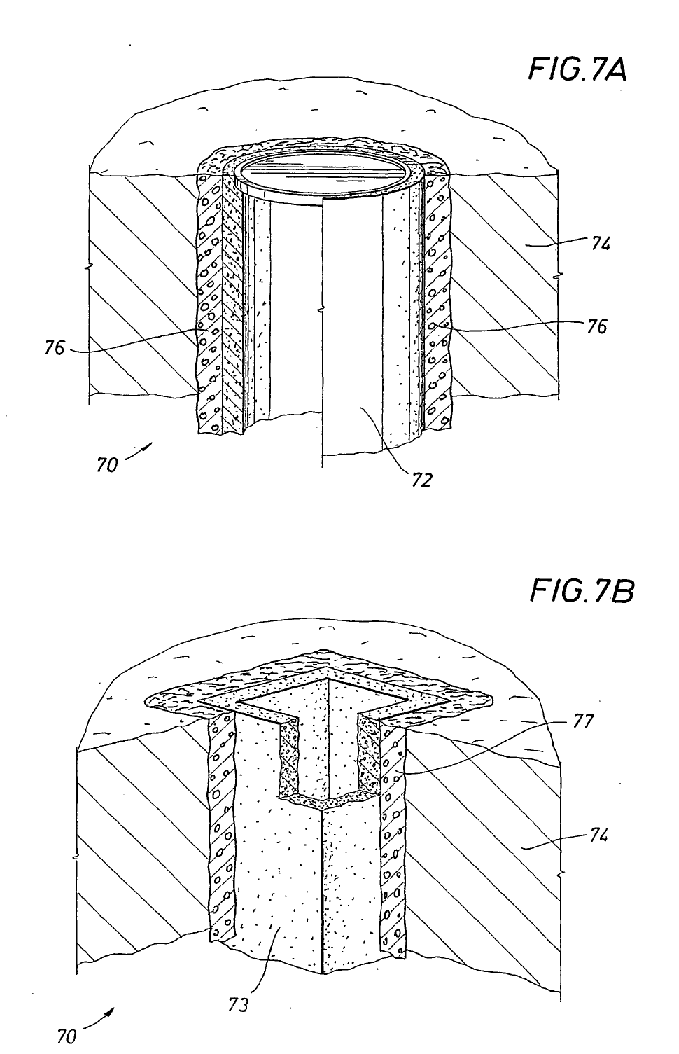

In still another embodiment, the composition and method of this invention may be used to seal an interface between a roadway and a roadway structure, as shown in FIGS. 7-10. Each interface shown may be sealed with a composition of this invention which includes an ethylene-unsaturated carboxylic acid co-polymer, such as EAA, with or without a rubberized compound. In the case of EAA and rubberized tar, an EAA-rubberized tar matrix forms an impact resistant adhesive bond between the roadway and roadway structure. The rubberized tar in the matrix absorbs and transmits energy forces resulting in improved low temperature toughness over EAA alone. The roadway structures include manhole boxes, drain boxes, roadway curbs and expansion joints.

In FIG. 7A, the composition of this invention is shown in a construction use, sealing roadway structure 70, shown as manhole shaft 72. Interface 76 is located as a annulus around manhole shaft 72 and roadway 74. Roadway 74 may be an asphalt or a concrete surface. The manhole shaft 72 may be fabricated from metal or concrete. FIG. 7B shows manhole shaft 72 having a rectangular cross-section that may be sealed by a composition of this invention. Interface 77 is located around the perimeter of manhole shaft 73.

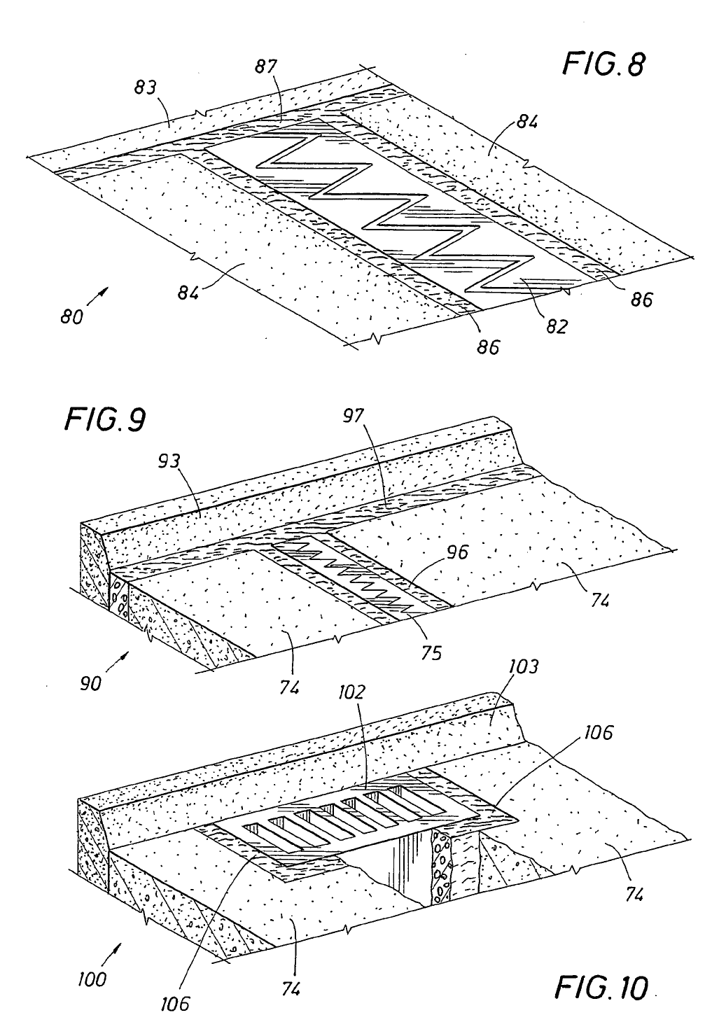

FIG. 8 shows the composition of this invention in another construction use, sealing roadway structure 80, such as a bridge expansion joint 82. Interface 86 is located between a bridge surface 84 that is proximate a bridge expansion joint 82. The interface 86 may also be located between a bridge structural member 83, such as a bridge wall or lane divider, and/or bridge surface 84 and/or the bridge expansion joint 82. The bridge surface may be metal, asphalt or concrete.

FIG. 9 shows the composition of this invention in a construction use, for sealing road structure 90, such as a roadway curb 93 and expansion joint 75. Interface 96 is located between a roadway expansion joint 75 and a road surface 74 and is sealed with the composition of this invention, as noted above. Interface 97 is located between an expansion join 75 and roadway 74 and roadway curb 93 may also be sealed with the composition of this invention.

FIG. 10 shows the composition of this invention in a construction use, for sealing roadway drain 100. Interface 106 between a roadway drain 102 and a roadway 74 and/or roadway curb 103 is shown sealed with the composition of this invention.

The present invention includes a method of repairing a roadway curb which includes placing a mold proximate a portion of a roadway curb to be repaired. A fine spray of a lubricator/solvent, such as WD-40 or the like, is applied to the mold. The ethylene-unsaturated carboxylic acid co-polymer is heated with a heat source until substantially melted. The substantially melted co-polymer is poured into the mold to repair the hole in the roadway curb when the melted co-polymer is substantially solidified and the mold is removed from the roadway curb. There have been many attempts made to do this to the inventor's knowledge and they did not work because the EAA adhered to the mold. It was either impossible to get the mold off or the EAA brought some of the curb with it when the mold was removed (EAA stuck to the mold). In order to prevent this several coatings have been unsuccessfully tested. Crisco, vegetable oil, olive oil and motor oil were all tried and failed. If enough was placed into the vessel then it mixed with the EAA and ruined the mixture. A fine spray of WD-40 on the mold shortly before the application does two things: the solvent in WD-40 attacks the carboxyl groups and presents adhesion and the lubricating qualities of WD-40 helps the removal of the mold.

The composition and method of the present invention has several advantages as compared to the prior art compositions and methods. The composition and method of the present invention is faster than traditional methods. The traditional method, on the other hand, requires several trucks for patching potholes. Usually, one truck is required for moving the roller, another is required for the asphalt, and a third truck is needed for carrying the asphalt “tacking” solution (initial spray). The traditional method requires a roller. In the United States an expensive eleven-ton roller is often used. The asphalt has to be mixed at a mixing plant and carried to the location. Unless a heated truck is used, this has to be done very quickly (timing is required to prevent lost time). Several passes have to be made over the traditional patch to compress the asphalt. Extra material is added each time to fill the compression that is caused by the roller. This is time consuming. Due to the actions outlined above, the typical crew consists of 5 or 6 men (including truck drivers).

To apply the composition and method of this invention for asphalt or concrete requires approximately 10 minutes and approximately another 20 minutes to harden. This is a considerably shorter time span than using the conventional patching method for asphalt. This composition and method requires less equipment and manpower to use. Only a pickup or small trailer is required for asphalt or concrete applications. A two-man crew is preferred, however, one may be sufficient.

The composition and method of the present invention is less expensive due to the reduction in personnel and equipment. The government estimates that to fill a 2′×2′ pothole costs about $60 using the composition and method of this invention versus a $250 for the conventional method. Although the composition is more expensive than asphalt, the reduced equipment and labor costs reduce overall costs. For example, it may take a two-man crew 2 2 to 4 hours to fill twenty potholes over a two mile stretch, depending on the spacing of the holes. If the holes are close together, the men could work independently filling potholes. The material and equipment could be carried on a pick up truck. A trailer would not be necessary.

The actual repair or patch of a roadway using the composition and/or method of this invention is longer lasting and provides a better adhesive sealant than the conventional method of patching potholes in concrete or asphalt roadways.

This invention may be distinguished from prior art materials by the fact that it bonds with the surrounding material and therefore it has better adherence with the surrounding material together. As a result, a more watertight seal is formed, leading to much longer road wear life. Rubberized tar alone may be used to fill cracks, but it does not have adhesive properties and therefore as long a life as the composition and method of this invention. There are also some epoxy compounds that will bond with the surrounding materials. However, these compounds do not have the same resiliency and elasticity as the surrounding material, as in the composition of this invention. Moreover, the useful life of epoxy compounds is severely limited in paving applications due to the heavy vehicle loads and the temperature expansion effects encountered in roadway applications.

When paving large surfaces or areas, the composition and method of this invention may have a short-tern cost disadvantage as compared to asphalt. However, in cases such as metal bridges, where normal methods (asphalt or concrete) will not adhere, this method is the most cost effective as it works better than the traditional methods.

Other considerations for this invention are that the patch is only as good as the integrity of the surrounding material. If the surrounding asphalt is crumbling or does not have integrity then the patch is adhering to material that will continue to be weak. In this case the entire patch might come out of the road surface. As per above, the crews must clear away debris and crumbling asphalt or road material. If this is not done properly then the patch will fail. In some cases if the road or surface is in very bad shape, this patch method should not be used and the entire surface should be replaced. Crews need to be trained to spot these conditions.

In the present invention, the substantially melted mixture may be poured into a cleaned pothole and depending on the ambient temperature, traffic can be going over the repaired patch in less than 30 minutes. The total repair can be done in less than 15 minutes with cooling another 15-30 minutes, depending upon ambient temperature. This is a huge improvement in the time for the repair for a repair that has a comparable life span.

The composition and method of the present invention is more permanent that conventional methods. Such methods, such as the “throw and go” method, usually last no more than a few months or weeks. A traditional permanent repair takes a very long time and a lot of capital equipment, as noted above. This method only takes on or two man crews with little capital equipment.

Also, the adhesive seal formed using the composition is more moisture resistant than conventional methods. The strong adhesive properties make a very good seal to the sides of the pothole, better than the surrounding road material. Other resins do not have the adhesive properties that the EAA has so they would require additional adhesives (such as EAA) to bond to the sides of the road (or road surfaces). The composition of this invention may be used to seal manhole covers or to seal cracks or as a paving compound for metal bridge surfaces.

The composition of this invention is stronger and more resilient than the surrounding concrete or asphalt material. The composition of this invention, unlike epoxy, may be modified to give characteristics and physical properties that approximate the surrounding material. The surrounding material, therefore, is not subjected to additional stress. That is, the composition of this invention may be structured to “flex” along with the surrounding material thus absorbing some of the stresses.

Moreover, the composition of this invention may be modified to fit different grades of asphalt or concrete. This is particularly applicable to areas which experiences wide temperature swings and varying weather patterns. The composition and method of this invention may be applied to concrete as well as asphalt surfaces, particularly with respect to repairing potholes and the like. The composition may be used as a paving material such as for bridge decks. Other applications of the composition and method of this invention include streets and highways, airport runways, parking lots, bridge decks and structural members.

The foregoing description of a preferred embodiment of the invention has been presented for purposed of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

It is claimed:

1. A composition for sealing, paving or repairing surfaces, comprising:
a mixture of a rubberized compound and an ethylene-unsaturated carboxylic acid co-polymer having a carboxylic acid content from about 0.5 to about 40 weight percent of the co-polymer.

2. The composition of claim 1 wherein the ethylene-unsaturated carboxylic acid co-polymer is selected from a group consisting essentially of at least one of acrylic acid, methacrylic acid, ethacrylic acid, crotonic acid, vinyl acetic acid, maleic acid and fumaric acid.

3. The composition of claim 1 wherein the rubberized compound is selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires.

4. The composition of claims 1, 2 or 3 further comprising a reinforcing agent selected from a group consisting essentially of aggregate, metal rods and plastic strips.

5. The composition of claims 1, 2, 3 or 4 further comprising modifying agent selected from a group consisting of essentially natural and synthetic fibers, calcium carbonate, talc and other minerals.

6. The composition of claims 1, 2, 3, 4 or 5 further comprising a coloring agent or dye to adjust the appearance of the composition.

7. A composition for sealing or paving surfaces, comprising:
1 a mixture of a rubberized compound, an ethylene-unsaturated carboxylic acid co-polymer having a carboxylic acid content from about 0.5 to about 40 weight percent of the co-polymer, a modifying agent and a reinforcing agent, the co-polymer selected from a group consisting essentially of at least one of acrylic acid, methacrylic acid, ethacrylic acid, crotonic acid, vinyl acetic acid, maleic acid and fumaric acid, the rubberized compound selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires, the modifying agent selected from a group consisting essentially of at least one of natural and synthetic fibers, calcium carbonate, talc and other minerals, the reinforcing agent selected from a group consisting essentially of at least one of aggregate, metal rods and plastic strips.

8. The composition of claim 7 wherein the co-polymer is about 50 weight percent and the rubberized compound is about 50 weight percent of the composition.

9. The composition of claim 7 wherein the co-polymer is about 80 weight percent and the rubberized compound is about 20 weight percent of the composition.

10. A method of applying an impact resistant and adhesive paving compound to a surface, comprising the steps of:
forming a paving mixture of a rubberized compound and an ethylene-unsaturated carboxylic acid co-polymer having a carboxylic acid content from about 0.5 to about 40 weight percent of the co-polymer, the rubberized compound selected from a group consisting essentially of at least one of butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires, the ethylene-unsaturated carboxylic acid co-polymer selected from a group consisting essentially of at least one of acrylic acid, methacrylic acid, ethacrylic acid, crotonic acid, vinyl acetic acid, maleic acid and fumaric acid;
heating the mixture with a heat source until the mixture is substantially melted; and
applying the mixture to a surface wherein the co-polymer and the rubberized compound form impact resistant and adhesive bonds with the surface when the melted mixture is substantially solidified.

11. A method of applying an adhesive paving compound to surface, comprising the steps of:
heating an ethylene-unsaturated carboxylic acid co-polymer having a carboxylic acid content from about 0.5 to about 40 weight percent of the co-polymer, the ethylene-unsaturated carboxylic acid co-polymer selected from a group consisting essentially of at lest one of acrylic acid, methacrylic acid, ethacrylic acid, crotonic acid, vinyl acetic acid, maleic acid and fumaric acid with a heat source until the co-polymer is substantially melted to form a paving compound; and
applying the co-polymer to a surface wherein the co-polymer forms an adhesive bonds with the surface when the co-polymer substantially solidifies.

12. The method of claims 10 or 11 wherein the surface including at least one of a bridge deck, a roadway, airport runway or apron, a parking lot, a loading dock, a building floor, a wall, a pool/pond bottom and a sidewalk.

13. The method of claims 10 or 11 further comprising the step of adding a reinforcing agent to the substantially melted substance, the reinforcing agent including at least one of aggregate, metal rods and plastic strips.

14. A method for repairing a hole in a paved surface, comprising:
mixing a rubberized compound with an ethylene-unsaturated carboxylic acid co-polymer having a carboxylic acid content from about 0.5 to about 40 weight percent of the co-polymer to form a mixture, the rubberized compound selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires; the ethylene-unsaturated carboxylic acid co-polymer selected from a group consisting essentially of at least one of acrylic acid, methacrylic acid, ethacrylic acid, crotonic acid, vinyl acetic acid, maleic acid and fumaric acid;
heating the mixture with a heat source until the mixture is substantially melted; and
pouring the mixture into a hole in a paved surface wherein the hole in the paved surface is repaired when the melted mixture is substantially solidified.

15. The method for repairing a hole in a paved surface of claim 14 further comprising the step of placing a reinforcing agent in the hole before pouring the substantially melted mixture into the hole.

16. The method for repairing a hole in a paved surface of claim 15 wherein the reinforcing agent includes at least one of aggregate, metal rods and plastic strips.

17. The method for repairing a hole in a paved surface of claim 14 wherein the heating step includes heating the hole prior to adding the substantially melted mixture.

18. A method of sealing an outdoor structural surface other than a roadway comprising the steps of:
heating an ethylene-unsaturated carboxylic acid co-polymer having a carboxylic acid content from about 0.5 to about 40 weight percent of the co-polymer with a heat source until the co-polymer is substantially melted, the co-polymer selected from a group consisting essentially of at least one of acrylic acid, methacrylic acid, ethacrylic acid, crotonic acid, vinyl acetic acid, maleic acid and fumaric acid; and
applying the selectively adjusted co-polymer to one or more outdoor structure surfaces other than a roadway so that the co-polymer forms adhesive bonds that seals said surfaces.

19. A method of sealing an outdoor structural surface comprising the steps of:
mixing a rubberized compound and an ethylene-unsaturated carboxylic acid co-polymer having a carboxylic acid content from about 0.5 to about 40 weight percent of the co-polymer to form a mixture, the co-polymer selected from a group consisting essentially of at least one of acrylic acid, methacrylic acid, ethacrylic acid, crotonic acid, vinyl acetic acid, maleic acid and fumaric acid; the rubberized compound selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires;
heating the mixture with a heat source until the mixture is substantially melted;
selectively adding one or more additive compounds to adjust the physical properties of the substantially melted mixture, the one or more additive compounds including at least one of metal flakes, ceramic flakes, natural fibers, synthetic fibers, calcium carbonate, talc, other minerals; the physical property including at least one of ductility, toughness, elastic modulus, compression modulus, flexural modulus, tensile strength and flexural strength; and
applying the selectively adjusted mixture to one or more surfaces so that the mixture forms impact resistance adhesive bonds with said surfaces.

20. The method of sealing surfaces of claims 18 or 19 wherein the surface of the applying step including at least one of a bridge column, a bridge pier, a wall, a pool/pond bottom and a roof.

21. A method of applying an impact resistant and adhesive seal to an interface between a roadway and a roadway structure comprising the steps of:
mixing a rubberized compound and an ethylene-unsaturated carboxylic acid co-polymer having a carboxylic acid content from about 0.5 to about 40 weight percent of the co-polymer to form a mixture, the co-polymer selected from a group consisting essentially of at least one of acrylic acid, methacrylic acid, ethacrylic acid, crotonic acid, vinyl acetic acid, maleic acid and fumaric acid, the rubberized compound selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires;
heating the mixture with a heat source to form a substantially melted mixture; and
applying the mixture to an interface between a roadway and a roadway structure to form an impact resistant adhesive bond or seal between said roadway and roadway structure.

22. A method of applying an adhesive seal to an interface between a roadway and a roadway structure comprising the steps of:
heating an ethylene-unsaturated carboxylic acid co-polymer having a carboxylic acid content from about 0.5 to about 40 weight percent, the co-polymer selected from a group consisting essentially of at least one of acrylic acid, methacrylic acid, ethacrylic acid, crotonic acid, vinyl acetic acid, maleic acid and fumaric acid with a heat source to form a substantially melted co-polymer; and
applying the co-polymer to an interface between a roadway and a roadway structure to form an adhesive bond or seal between said roadway and roadway structure.

23. The method of sealing surfaces of claims 21 or 22 wherein the roadway structure of the applying step including at least one of a manhole box, a drain box, a roadway curb and an expansion joint.

24. A method of modifying the physical properties of a paving and/or sealing compound containing ethylene acrylic acid, comprising the steps of:
selecting a physical property for a paving and/or sealing compound containing ethylene acrylic acid, the physical property including at least one of ductility, toughness, elastic modulus, compression modulus, flexural modulus, tensile strength and flexural strength;
determining a desired value of the physical property for the compound containing ethylene acrylic acid;
adding an effective amount of an adjusting compound to an amount of the compound containing ethylene acrylic acid to adjust the physical property of the mixture to the desired value of the physical property, the adjusting compound including at least a rubberized compound.

25. The method of modifying the physical properties of a compound containing ethylene acrylic acid of claim 24 wherein the rubberized compound is selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires.

26. The method of modifying the physical properties of a compound containing ethylene acrylic acid of claims 24 or 25 wherein the adjusting agent includes a reinforcing agent having at least one of aggregate, metal rods and plastic strips.

27. The method of modifying the physical properties of a compound containing ethylene acrylic acid of claims 24 or 25 wherein the adjusting compound includes a modifying agent having at least one of natural and synthetic fibers, calcium carbonate, talc and other minerals.

28. A method of repairing a roadway curb, comprising the steps of:
placing a mold proximate a portion of a roadway curb to be repaired;
applying a fine spray of a lubricator/solvent to the mold shortly before application;
mixing a rubberized compound with an ethylene-unsaturated carboxylic acid co-polymer having a carboxylic acid content from about 0.5 to about 40 weight percent of the co-polymer to form a mixture, the rubberized compound selected from a group consisting essentially of at least one of natural rubber, butadiene homopolymer, styrene-butadiene co-polymer, methacrylic oligomer, polymeric rubberized tar, ethylene-propylene-ethylidene norborne terpolymers, polyisoprene rubber, rubberized asphalt and ground rubber tires; the ethylene-unsaturated carboxylic acid co-polymer selected from a group consisting essentially of at les tone of acrylic acid, methacrylic acid, ethacrylic acid, crotonic acid, vinyl acetic acid, maleic acid and fumaric acid;
heating the mixture with a heat source until the mixture is substantially melted;
pouring the mixture into the mold to repair the hole in the roadway curb when the melted mixture is substantially solidified; and
removing the mold from the roadway curb.

29. A method of repairing a roadway curb, comprising the steps of:
placing a mold proximate a portion of a roadway curb to be repaired;
applying a fine spray of a lubricator/solvent to the mold shortly before application;
heating an ethylene-unsaturated carboxylic acid co-polymer having a carboxylic acid content from about 0.5 to about 40 weight percent of the co-polymer, the ethylene-unsaturated carboxylic acid co-polymer selected from a group consisting essentially of at least one of acrylic acid, methacrylic acid, ethacrylic acid, crotonic acid, vinyl acetic acid, maleic acid and fumaric acid;
heating the co-polymer with a heat source until substantially melted;
pouring the co-polymer into the mold to repair the hole in the roadway curb when the melted co-polymer is substantially solidified; and
removing the mold from the roadway curb.

30. The method of claims 10, 11, 14, 18, 19, 21, 22, 28 or 29 wherein the mixture is substantially melted prior to applying or pouring.

31. The method of claim 18 that includes adding at least one additive compound, modifying agent or reinforcing agent to selectively adjust a physical property of the substantially melted copolymer, the additive compound including at least one of metal flakes and ceramic flakes, the modifying agent including at least one of natural fibers, synthetic fibers, calcium carbonate, talc, other minerals, the reinforcing agent including at least one of selected from the group consisting of aggregate, metal rods and plastic strips, the physical property selected from a group consisting essentially of at least one of ductility, toughness, elastic modulus, compression modulus, flexural modulus, tensile strength and flexural strength.
